(19) United States
(12) Patent Application Publication
(10) Pub. No.: US 2022/0403215 A1
(43) Pub. Date: Dec. 22, 2022

(54) ROOFING UNDERLAYMENT USING A PRESSURE SENSITIVE ADHESIVE AND METHODS FOR MAKING AND USING THE SAME

(71) Applicant: Bostik, Inc., Wauwatosa, WI (US)

(72) Inventors: David P. Keuler, Wauwatosa, WI (US); Cory C. Bausch, Wauwatosa, WI (US); Mark D. Alper, Wauwatosa, WI (US)

(21) Appl. No.: 17/638,300

(22) PCT Filed: Aug. 25, 2020
(86) PCT No.: PCT/US2020/047809

§ 371 Date: Feb. 25, 2022

Related U.S. Application Data
(60) Provisional application No. 62/891,710, filed on Aug. 26, 2019.

(51) Int. Cl. C09J 7/38; E04D 12/00; C09J 7/40; C09J 11/04; C09J 11/08; C09J 119/00; C09J 125/08; C09J 153/00

(52) U.S. Cl. CPC C09J 7/387; E04D 12/002; C09J 7/40; C09J 11/04; C09J 11/08; C09J 119/006; C09J 125/08; C09J 153/005; C09J 2203/346; C09J 2301/302; C09J 2301/408; C09J 2301/502; C09J 2471/006; C09J 2400/263

(57) ABSTRACT

A roofing underlayment capable of adhering to a roof deck comprising: (a) a roofing membrane having a first and a second major surface; and (b) a pressure-sensitive adhesive disposed on the first major surface of the roofing membrane and comprising: (i) at least one of butyl rubber or polyisobutylene; (ii) a first liquid plasticizer, preferably polybutene; and (iii) a tackifier, wherein the Tg of the adhesive is at most about 100 C. The adhesive provides high bond strength and excellent long-term heat aging, weathering resistance, as well as good low temperature properties while providing a moisture proof seam. A method for making the roofing underlayment includes applying the adhesive to the membrane then applying a release liner over the adhesive layer. A method for using the roofing underlayment comprises removing the release liner then adhering the underlayment to the roof deck by contacting the first to the roof deck.

### CROSS-REFERENCE TO RELATED APLICATION

This application claims priority under 35 U.S.C. § 119(e) to U.S. Patent Application No. 62/891,710, filed Aug. 26, 2019.

### FIELD OF THE INVENTION

The present invention relates to a roofing underlayment using an adhesive that is useful to attach such underlayments to a roof deck. Specifically, the present invention relates to roofing underlayments using an adhesive composition that is pressure sensitive and may be utilized to apply a roofing membrane in a peel and stick manner.

### BACKGROUND OF THE INVENTION

There are two broad types of roofing applications. The first is commercial roof applications, where the roof line tends to be flat or have a relatively low slope. In commercial roofing applications, roof sheeting materials such as ethylene-propylene-diene terpolymer (EPDM), butyl rubber, neoprene, polyvinyl chloride, chlorinated polyethylene, thermoplastic polyolefin (TPO) and modified bitumen, are often used as single-ply roofing membranes (also referred to as films) because they are well known in the art as having barrier properties against moisture. The roof sheeting materials are customarily attached to the roof deck using an adhesive. As used herein, a “roof deck” is used to refer to the substrate of a roof to which roofing underlayments are adhered and include insulation boards. The roof sheeting materials may be exposed to stresses such as roof movement, heavy winds, freeze-thaw cycles and thermal cycles. Therefore, the adhesive must be able to withstand such possible stresses.

Currently, roofing underlayments are adhered to roof decks utilizing a variety of methods. One such method involves the use of liquid based adhesives that employ natural and/or synthetic elastomers and resins in organic solvent systems. These liquid based adhesives do not always provide good bond strength and long-term durability. For example, if conditions during application are windy, dust or other debris may adhere to the adhesive and impair the quality of the bond. High temperatures may cause the adhesive to dry out too quickly. These environmental problems may complicate installation procedures. Additionally, liquid based adhesives often utilize organic solvents such as toluene and xylene. These solvents pose a health and fire hazard, and their use is undesirable.

Other methods of adhering commercial roofing membranes include the use of slow drying water based adhesives. Additionally, asphalt based adhesives that must be heated to a molten state and then swabbed onto the roofing surface may also be used. However, these asphalt adhesives require special equipment and can pose a fire risk. Heat welding of thermoplastic materials and nailing have also been utilized to secure roofing underlayments to roof decks. Cover strips, flashings, or other accessories have also been secured utilizing these processes. These processes may be extremely time consuming, hazardous or provide an inferior seam.

The second major type of roofing application is residential. For residential installations, the major use of underlayments is to prevent water or ice intrusion and protect from wind-driven rain underneath the roof shingles. Residential roofs tend to use shingles, metal, clay, concrete, or composite tiles and are generally sloped as opposed to commercial roofs which do not use shingles and are usually flat. Water and ice intrusion can happen if water running off the roof freezes on the cold gutters and blocks the water running off the roof. This can build up on the lower sections of the roof and seep under the shingles roofing surface causing the roof deck itself to become soaked or actually allow water into the attic or living quarters.

Residential roofing underlayments frequently have an adhesive coating which allows for a direct bonding to the roof deck and also provides nail sealability. If a nail or other fastener is driven through the shingle and roof underlayment, the adhesive can effectively seal around that intrusion so that no moisture can go through the underlayment. As can be appreciated, the temperature demands placed on adhesives used to adhere underlayments to roof decks are extreme. For example, the temperature during application vary greatly depending on the geographic location of the construction and the time of year of application. Moreover, the adhesive must be able to retain adhesion over a range of temperatures over the lifetime of a roof.

### SUMMARY OF THE INVENTION

There remains a need for an adhesive composition that effectively adheres roofing underlayments to a variety of materials with ease of application. The adhesive should provide high bond strength and excellent long-term heat aging, weathering resistance, as well as good low temperature properties while providing a moisture proof seam. Additionally, the adhesive should pose no environmental hazard. It is also desirable for such an adhesive to contribute to the sustainability of housing by reducing the likelihood that moisture finds its way into living quarters. It is an object of the present invention to provide a self-adhering roofing underlayment which balances these needs, especially having improved high and low temperature performance characteristics at the rigorous and extreme conditions faced by adhesives used to adhere roofing underlayments to roof decks.

According to an embodiment of the invention, a roofing underlayment capable of adhering to a roof deck comprises: (a) a roofing membrane having a first major surface and a second major surface; and (b) a pressure-sensitive adhesive disposed on the first major surface of the roofing membrane and comprising: (i) at least one of butyl rubber or polyisobutylene; (ii) a first liquid plasticizer, preferably polybutene; and (iii) a tackifier, wherein the Tg of the adhesive is at most about 10° C.

According to another embodiment of the invention, a method of making a roofing underlayment comprises the steps of: (a) applying a pressure-sensitive adhesive to a first major surface of a roofing membrane, wherein the adhesive comprises: (i) at least one of butyl rubber or polyisobutylene; (ii) a first liquid plasticizer; and applying a release liner over the adhesive layer that is applied to the first major surface of the roofing membrane, wherein the Tg of the adhesive is at most about 10° C.

According to another embodiment of the invention, a method of applying to a roof deck an underlayment comprising (a) a roofing membrane having a first major surface and a second major surface; (b) a pressure-sensitive adhesive layer disposed on the first major surface of the roofing membrane; and (c) a release liner applied over the pressure-sensitive adhesive, wherein the method comprises the steps of: (a) removing the release liner from the roofing underlayment to expose the adhesive layer and (b) adhering the underlayment to the roof deck by contacting the first major surface of the roofing membrane to the roof deck, wherein the adhesive comprises: (i) at least one of butyl rubber or polyisobutylene; (ii) a first liquid plasticizer; and (iii) a tackifier, wherein the Tg of the adhesive is at most about 10° C.

It is to be understood that both the foregoing general description and the following detailed description are exemplary, but are not restrictive, of the invention.

### BRIEF DESCRIPTION OF THE DRAWING

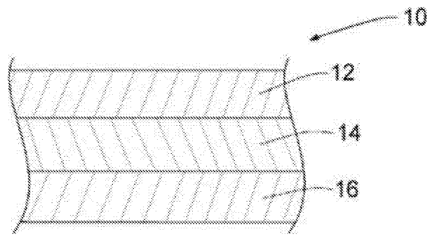

The invention is best understood from the following detailed description when read in connection with the accompanying drawing, in which FIG. 1 is a cross-sectional view of a roofing underlayment in accordance with one aspect of the present invention.

### DETAILED DESCRIPTION OF THE INVENTION

The present invention relates to a self-adhering waterproofing roofing underlayment that performs well at both high and low temperatures. The roofing underlayment is in the form of a sheet-like laminate and comprises a roofing membrane and a pressure sensitive adhesive layer, wherein the adhesive comprises a pressure sensitive composition based on butyl rubber or polyisobutylene. The adhesive composition also includes a tackifying resin and at least one plasticizer, and may also include other constituents, and is formulated to have a Tg of at most about 10° C. The adhesive composition has been found not to lose adhesion or tack over time or become brittle, which could result in debonding from the roof deck and loss of nail sealability properties.

The roofing membrane also may optionally include a removable release liner on the adhesive layer to prevent the membrane from adhering to itself when rolled up (i.e., to prevent the adhesive layer from adhering to the side of the roofing membrane opposite the adhesive layer). The adhesive used in the roofing membrane of the present invention has excellent adhesion (at both high and low temperatures), excellent sag resistance (at high temperature), and excellent flexibility without cracking (at low temperature). The adhesive composition may be applied in a peel and stick manner, and poses no environmental hazard.

Referring the FIG. 1, there is shown a roofing underlayment 10 in accordance with the present invention. Roofing underlayment 10 includes a roofing membrane 12, a pressure sensitive adhesive 14 adhered to a first major surface of the roofing membrane, and a release liner 16 on the side of the pressure sensitive adhesive opposite of the roofing membrane and adhered to the roofing membrane by the adhesive.

Roofing underlayment 10 is securely attached to a roof deck, which might be a parapet wall or curb or insulation board, to form a water-impervious structure. The roof deck may be constructed from plywood, oriented strand board (OSB), metal decking, or concrete, or any other suitable material. On existing construction, roofing underlayment 10 may be applied to a smooth asphalt top surface. If desired, roofing underlayment 10 may also include an insulation barrier formed from polyisocyanurate or any other suitable material applied over the roof deck. A suitable primer may be used on the surface of the roof deck to enhance the adhesion of the roofing underlayment.

Roofing membrane 12 of roofing underlayment 10 is formed of, for example, from appropriate thermosetting materials and thermoplastic materials including polyvinyl chloride (PVC), thermoplastic olefin (TPO), polyethylene and polypropylene, chlorinated polyethylene (CPE), chloro-sulphinated polyethylene (CSPE) and polyisobutylene (PIB). Suitable thermosetting materials are EPDM, butyl rubber, and neoprene. The roofing underlayments 10 may be single ply membrane or a multi-layered structure, and may or may not include reinforcing meshes or scrims located intermediate layers 12 and 14.

Examples of roofing membranes are described in U.S. Pat. No. 7,745,353, incorporated herein by reference. A roofing membrane described therein includes a woven polypropylene or polyethylene fabric to form a scrim later, optionally having an anti-slip coating at the second major surface of the roofing membrane. More specifically, the '353 patent describes a roofing membrane comprising a woven polyethylene or polypropylene scrim which is extrusion coated on at least one side with an anti-slip coating layer. The anti-slip coating layer comprises a compound based on a styrene and ethylene/butylene-styrene, S-E/B-S, block copolymer, such as the compound sold under the trademark KRATON® MD6649.

The roofing membrane 12 may range in thickness from about 5 miles to about 90 mils thick, preferably 10-45 mils, more preferably between about 10-35 mils and most preferably between about 10-25 or 10-20 mils. The roofing membrane 12 may range from about 6 inches-12 feet wide and of indeterminate length depending upon the intended application. For example, when the preformed roofing underlayment 10 is installed over the roof deck of a roofing installation, the roofing membrane ranges from 6 inches to 3 feet or 4 feet in width and indeterminate in length as desired.

Adhered to one side of the roofing membrane 12 is the pressure sensitive adhesive 14. The pressure sensitive adhesive 14 is applied directly to the roofing membrane 12 using most any suitable method well-known in the art. The pressure sensitive adhesive may be a hot melt adhesive or an extrudable adhesive. For example, the pressure sensitive adhesive 14 may be applied directly to the roofing membrane 12 using hot melt drum unloaders, a hot melt spray method, and/or a slot die method, as well known in the art. Typically, if the adhesive contains a large amount of a filler, it would be applied using an extruder. It will be appreciated that by applying the pressure sensitive adhesive 14 directly to the roofing membrane 12, better and more uniform bond strength may be achieved in contrast to the use of a transfer adhesive.

Pressure sensitive adhesives 14 in accordance with the present invention are solvent-free adhesives, that are characteristically solid at temperatures below 180° F., are low viscosity fluids above 180° C., and rapidly set upon cooling. Preferably, pressure sensitive adhesive 14 does not include a curing or cross linking agent whereby the adhesive maintains the desired thermo-plastic properties. In an embodiment, the adhesive layer 14 has a thickness between about 4 mils and about 50 mils, preferably between about 6 mils and about 30 mils, more preferably between about 8 mils and about 25 mils, and most preferably between about 10 mils and about 20 mils. In another embodiment, the adhesive layer 14 has a thickness of at least about 16 mils, preferably at least about 18 mils, more preferably at least about 20 mils, and most preferably at least about 22 mils.

The pressure-sensitive adhesive in accordance with an aspect of the invention comprises: (i) at least one of butyl rubber or polyisobutylene; (ii) at least one liquid plasticizer, preferably a polybutene plasticizer; and (iii) a tackifier. Butyl rubber is widely used to make many different types of adhesives. It is a copolymer of isobutylene and isoprene, generally containing from about 1% to 3% isoprene. Commercial grades are available from ExxonMobil as Exxon butyl rubber 065, 268 and 365. They are also available from Lanxess Corporation under grades Butyl RB 301, RB 402, etc.

The polyisobutylene may be a high molecular weight polyisobutylene such as Oppanol N-50. N 100 or N150 available from BASF Corporation. The polyisobutylene of the present adhesive composition may also be a low molecular weight polyisobutylene such as Opponol B-10 or B-15, available from BASF Corporation. Additionally, the polyisobutylene component may be a combination of such polyisobutylenes.

Preferably, the adhesive comprises about 5 wt % to about 35 wt %, preferably about 10 wt % to about 30 wt %, more preferably about 12.5 wt % to about 25 wt % of the at least one of butyl rubber or polyisobutylene. In an embodiment, the at least one of butyl rubber or polyisobutylene is entirely butyl rubber and no polyisobutylene. In another embodiment, the at least one of butyl rubber or polyisobutylene is entirely polyisobutylene and no butyl rubber. In still another embodiment, the at least one of butyl rubber or polyisobutylene is a mixture of the two.

The first liquid plasticizer used herein may reduce viscosity or improve tack properties in the adhesive. Preferably, the first plasticizer is a polybutene plasticizer. Any polybutene liquid plasticizer known to a person of ordinary skill in the art may be used in the adhesive composition disclosed herein. The polybutene liquid plasticizers used herein may have low molecular weight, such as having a molecular weight as low as 200 g/mol, in particular, those in the range of from about 200 g/mol to 6000 g/mol, and preferably in the range of from about 800 g/mol to about 2000 g/mol.

Preferably, the adhesive comprises about 10 wt % to about 50 wt %, preferably about 15 wt % to about 45 wt %, more preferably about 17.5 wt % to about 40 wt % of the polybutene liquid plasticizer. Individual grades or various grades in combination may be used as the polybutene liquid plasticizer. Other suitable plasticizers may be used, such as low viscosity polyalphaolefin-based plasticizers, including those sold under the trademark SpectraSyn™ by ExxonMobil.

The tackifying resins or tackifiers which are used in the adhesives of the present invention are those which extend adhesive properties and improve specific adhesion. As used herein, the term “tackifying resin” includes:
(a) aliphatic and cycloaliphatic petroleum hydrocarbon resins having Ring and Ball softening points of from 10 degrees centigrade to 160 degrees centigrade, as determined by ASTM method E28-58T, the latter resins resulting from the polymerization of monomers consisting primarily of aliphatic and/or cycloaliphatic olefins and diolefins; also included are the hydrogenated aliphatic and cycloaliphatic petroleum hydrocarbon resins; examples of such commercially available resins based on a C5 olefin fraction of this type are Piccotac 95 tackifying resin sold by Eastman Chemical Company, and Escorez 1310LC sold by ExxonMobil Chemical Company;
(b) Aromatic petroleum hydrocarbon resins and the hydrogenated derivatives thereof;
(c) Aliphatic/aromatic petroleum derived hydrocarbon resins and the hydrogenated or acid functionalized derivatives thereof;
(d) Aromatic modified cycloaliphatic resins and the hydrogenated derivatives thereof;
(e) Polyterpene resins having a softening point of from about 10 degrees centigrade to about 140 degrees centigrade, the latter polyterpene resins generally resulting from the polymerization of terpene hydrocarbons, such as the mono-terpene known as pinene, in the presence of Friedel-Crafts catalysts at moderately low temperatures; also included are the hydrogenated polyterpene resins;
(f) Copolymers and terpolymers of natural terpenes, e.g. styrene/terpene, alpha-methyl styrene/terpene and vinyl toluene/terpene;
(g) natural and modified rosin such as, for example, gun rosin, wood rosin, tall-oil rosin, distilled rosin, hydrogenated rosin, dimerized rosin and polymerized rosin;
(h) glycerol and pentaerythritol esters of natural and modified rosin, such as, for example, the glycerol ester of pale wood rosin, the glycerol ester of hydrogenated rosin, the glycerol ester of polymerized rosin, the pentaerythritol ester of pale wood rosin, the pentaerythritol ester of hydrogenated rosin, the pentaerythritol ester of tall-oil rosin, and the phenolic modified pentaerythritol ester of rosin; and
(i) phenolic-modified terpene resins such as, for example, the resin product resulting from the condensation in an acidic medium of a terpene and a phenol.

Mixtures of two or more of the above described tackifying resins may be required for some formulations. Tackifying resins which are useful for the present invention can include polar tackifying resins.

The preferred tackifiers for this invention are C5 resins, mixed C5/C9 resins and partially or fully hydrogenated C5, C9 and C5/C9 resins having softening points of at least about 80 degrees centigrade, but preferably less than about 140 degrees centigrade, more preferably less than about 115 degrees centigrade, and most preferably less than about 110 degrees centigrade These resins are used from about 0 percent to about 50 percent by weight of the composition, more preferably from about 0 percent to about 40 percent by weight and most preferably from about 0 percent to about 30 percent by weight of the composition.

Tackifying resins which are useful within the scope of the present invention can be selected from any of the nonpolar types, which are commercially available. The most preferred resins are hydrocarbon tackifiers, especially aliphatic petroleum hydrocarbon resins examples of which are based on C5 olefins such as Piccotac 9095 available from Eastman Chemical Company, Kingsport, Tenn. Most preferred are nonpolar products which are hydrogenated DCPD based or aromatically modified derivatives thereof with softening points above 70 degrees centigrade Examples of such resins are Escorez® 5400 and Escorez® 5600 sold by ExxonMobil Chemical Company. Other preferred tackifiers include the Sukorez® hydrogenated hydrocarbon tackifiers sold by Kolon Industries, such as Sukorez® SU-100 and Sukorez® SU-400.

Preferably, the adhesive comprises about 2.5 wt % to about 40 wt %, preferably about 4 wt % to about 35 wt %, more preferably about 5 wt % to about 30 wt % of the tackifier. Individual or various grades in combination may be used as the polybutene liquid plasticizer.

The adhesive may also further comprise a styrene block copolymer. A wide variety of styrenic block copolymers (SBCs) are useful as in the present invention, and, if present, are present in an amount of about 2.5 wt % to about 25 wt %, preferably about 5 wt % to about 20 wt %, more preferably about 7.5 wt % to about 15 wt % of the styrene block copolymer, in the adhesive composition. These SBC polymers include A-B-A triblock structures, A-B diblock structures, (A-B)ₙ radial block copolymer structures, as well as branched and grafted versions of such, wherein the A endblock is a non-elastomeric polymer block, typically polystyrene, and the B block is an unsaturated conjugated diene or hydrogenated version thereof. In general, the B block is typically isoprene, butadiene, ethylene/butylene (hydrogenated butadiene), ethylene/propylene (hydrogenated isoprene), ethylene-ethylene/propylene (hydrogenated isoprene/butadiene) and mixtures thereof.

There are many different types of styrenic block copolymers available today in the marketplace. They are available in a number of different chemical types and structure types. Examples of the styrenic block copolymers (SBC) that may be used in the present inventive composition include styrene-butadiene (SB), styrene-butadiene-styrene (SBS), styrene-isoprene-styrene (SIS), styrene-isoprene (SI), styrene-isoprene-butadiene-styrene (SIBS), styrene-ethylene-butylene-styrene (SEBS), styrene-ethylene-butylene (SEB), styrene-ethylene-propylene-styrene (SEPS), styrene-ethylene propylene (SEP) and styrene-ethylene-ethylene-propylene-styrene (SEEPS or hydrogenated SIBS). Preferably, the SBC comprises or consists of a hydrogenated SBC, and more preferably comprises or consists of SEBS.

For purposes of the present invention, it is preferred that the styrene endblocks of the copolymer comprise about 10 percent to about 40 percent by weight of the copolymer, the midblocks of the styrenic block copolymer be hydrogenated, and the copolymer have a melt index less than about 30 grams/10 minutes.

Commercially available styrenic block copolymers useful in the present composition include the Kraton G series block copolymers, available from Shell Chemical Company (Houston, Tex.), and Septon 2000, 4000, 8000 grades of block copolymers, available from Kuraray Co. Ltd. Within the range of SEBS polymers, it has been found that those with about 30 percent styrene or lower have good compatibility in the present composition. Particularly preferred is Kraton G1652M, which is manufactured by Kraton Performance Polymers. This polymer has a styrene content of 29 percent, a Melt Index (ASTM D1238, 5 kg. 230 degrees centigrade) of 5 grams/10 minutes, and a diblock content of 0 percent. Other grades that are suitable include Kraton G1650, Kraton G1643 and Kraton G1657.

The adhesive composition may comprise a second plasticizer. The second plasticizer, which is typically liquid may be present in an amount of about 1 wt % to about 30 wt %, preferably about 2.5 wt % to about 20 wt %, more preferably about 5 wt % to about 10 wt %, in the adhesive composition. Plasticizers provide fluidity to the adhesive and decrease the viscosity, peel values, glass transition temperatures and cohesive strength. The plasticizers useful herein may include mineral and petroleum based hydrocarbon oils. The oils used are primarily hydrocarbon oils which are low in aromatic content and are paraffinic or naphthenic in character. This invention also contemplates the use of vegetable oils and their derivatives and similar plasticizing liquids.

A suitable second plasticizer may be selected from the group which includes the usual plasticizing oils, such as mineral oil, but also olefin oligomers and low molecular weight polymers, as well as vegetable and animal oils and derivatives of such oils. The petroleum derived oils which may be employed are relatively high boiling materials containing only a minor proportion of aromatic hydrocarbons. In this regard, the aromatic hydrocarbons should preferably be less than 30 percent and more particularly less than 15 percent of the oil, as measured by the fraction of aromatic carbon atoms. More preferably, the oil may be essentially non-aromatic.

The oligomers of the second plasticizer may be polypropylenes, hydrogenated polyisoprenes, hydrogenated polybutadienes, or the like having average molecular weight between about 350 g/mol. and about 10,000 g/mol. Suitable vegetable and animal oils include glycerol esters of the usual fatty acids and polymerization products thereof. The preferred second plasticizers that find usefulness in the present invention are mineral oil having an average molecular weight (all average molecular weights mentioned herein are weight-average molecular weights, Mw) less than 5,000 g/mol.

Exemplary mineral oils for use as the second plasticizer include: Kaydol oil, a white mineral oil commercially available from Sonneborn Inc., Parsippany, N.J.; and Nyflex 222B, a mineral oil purchased from Nynas USA Inc., Houston, Tex.

Preferably, the combined weight percentage of the polybutene liquid plasticizer and the second plasticizer is between about 15 wt % to about 50 wt %, preferably about 17.5 wt % to about 45 wt %, more preferably about 22.5 wt % to about 42.5 wt %.

Preferably, the adhesive further comprises a filler. The filler is preferably an inorganic filler and, if present, is preferably present in the composition in amounts of about 20 wt % to about 65 wt %, preferably about 30 wt % to about 60 wt %, and more preferably about 40 wt % to about 55 wt %. Inorganic fillers provide reinforcement and cohesive strength to the composition. The inorganic filler component useful in the present invention may be selected from any refined or processed material obtained as a result of the mining of minerals including talcs, clays, silicas, micas, limestones, marbles, and chalks. Of the various minerals listed, preference is given to the silica and calcium carbonate.

The adhesive composition may other optional ingredients. One such optional ingredient is an antioxidant stabilizer in an amount from about 0.1 percent to 5 percent by weight. Preferably from about 0.1 percent to 2 percent by weight of an antioxidant stabilizer is incorporated into the composition. A stabilizer or antioxidant can also be added to protect the composition from degradation caused by reaction with oxygen induced by such things as heat, light or residual catalyst from the raw materials such as the tackifying resin. Such antioxidants are commercially available from BASF and include Irganox 565, Irganox 1010 and Irganox 1076, all hindered phenolic antioxidants. These are primary antioxidants which act as free radical scavengers and may be used alone or in combination with other antioxidants such as phosphite antioxidants like Irgafos 168 available from BASF. Phosphite antioxidants are considered secondary antioxidants, are primarily used as peroxide decomposers and are generally not used alone, but are instead used in combination with other antioxidants. Other available antioxidants are Cyanox LTDP, a thioether antioxidant, available from Cytec Industries, Ethanox 330, a hindered phenolic antioxidant, available from Albemarle, and Naugard 445, a solid aromatic amine antioxidant, available from Chemturea. Many other antioxidants are available for use by themselves, or in combination with other antioxidants. These compounds are added to the sealants in small amounts, up to about 2 percent by weight in the composition and have no effect on the physical properties of the adhesive.

Other compounds that also could be added that have negligible effects on the physical properties are pigments which add color such as carbon black and titanium dioxide, fluorescing agents, weatherability improvers such as ultraviolet (UV) absorbers like Tinuvin™ P, 327 and 328 and UV scavengers such as Tinuvin™ 770 from Ciba-Geigy, and odor masks to mention only a few. Additives such as these are known to one of skill in the art. UV stabilizers are typically incorporated in amounts of from about 0 percent to 3 percent by weight, and preferably about 0.1 percent to 2 percent by weight. Other additives, such as pigments, may be incorporated in amounts of about 0 percent to 10 percent by weight, and preferably about 0.1 percent to 5 percent by weight.

It has been found that the glass transition temperature (Tg) and the crossover temperature (Tx) of the adhesive are important to achieving the particular combination of performance required by adhesives used in roofing underlayments. ASTM D 4440-01 is used to determine the Tg, Tx, the storage modulus, G′, and complex viscosity. The Tx is defined as the highest temperature at which the storage modulus, G′, and loss modulus, G″, intersect as measured using dynamic mechanical analysis (DMA) of the adhesive while cooled from the molten to solid state. The test method used is ASTM D 4440-01, with a cooling rate of 10° C./min. According to the invention, the adhesive has a Tg of at most about 10° C. In a preferred embodiment, the Tg of the adhesive is at most about 5° C., preferably at most about 0° C., more preferably at most about −5° C., and most preferably at most about −15° C. The lower limit of the Tg is not critical, but may be about −50° C. In still another preferred embodiment, the Tx of the adhesive is at least about 90° C., preferably between at least about 100° C., more preferably at least about 110° C., still more preferably at least about 130° C., and most preferably at least about 150° C. The upper limit of the Tx is not critical, but may be about 250° C. It is believed that both of these aspects of the adhesive, namely that the adhesive has a Tg below any of the upper limits of the Tg specified above and a Tx above any of the lower limits of the Tx specified above, are helpful to providing the properties critical to achieving the performance needed as an adhesive for a roofing underlayment. Another aspect of these characteristics of the adhesive is the difference between Tx of the adhesive and Tg of the adhesive. According to an embodiment of the invention, the difference between the Tx of the adhesive and Tg of the adhesive is at least about 100° C., preferably between at least about 110° C., more preferably at least about 130° C., still more preferably at least about 150° C., and most preferably at least about 170° C. In still another embodiment of the invention, the adhesive has a complex viscosity of about 5,000 to about 1,000,000 poise, preferably about 7,500 to about 750,000 poise, most preferably about 8,000 to about 600,000 poise.

A release liner 16 is applied against the pressure sensitive adhesive 14 to prevent premature unwanted adhesion and, in the case of rolls, ease of unwind without sticking to the backing. Release liner 16 is adhered to the first major surface of roofing membrane 12 by the pressure sensitive adhesive 14. Release liner 16 is applied after the application of the pressure sensitive adhesive 14. For ease of application, the release liner 16 may be sliced into multiple sections to allow for portioned release of the liner from the water impermeable membrane during application of the preformed self-adhering membrane 10. Release liner 16 may comprise paper, or polyethylene, polypropylene or polyester films of a type well known in the art. As shown in FIG. 1, the roofing membrane 12, pressure sensitive adhesive 14, and release liner 16 may be co-extensive. In another embodiment, the release liner 16 and pressure sensitive adhesive 14 may be coextensive and the combined release liner 16 and pressure sensitive adhesive 14 may be spaced from at least one marginal edge of the roofing membrane 12 to provide a free edge of water impermeable membrane, as described in U.S. Pat. No. 7,101,598, incorporated herein by reference. Preferably, the roofing underlayment after the removal of the release liner has a total thickness of the roofing membrane and the adhesive of greater than 40 mils.

The preformed roofing underlayment 10 as shown in FIG. 1 is joined to the roof deck by ‘peel and stick,’ namely by removing the release liner 16 and then pressing the pressure sensitive adhesive 14 directly to the roof substrate.

The roofing underlayment 10 with pressure sensitive adhesive 14 preferably has a minimum peel strength of 0.5 pounds per linear inch at 70° F. as determined in accordance with ASTM D 3330 for roofing applications. Furthermore, it is preferable that the underlayment passes ASTM D1970-18, Section 7.5, for 14 days at 121° C. (250° F.).

The method of making a roofing underlayment includes applying a pressure-sensitive adhesive 14 as described herein to a first major surface of roofing membrane 12 in a manner as described above (e.g., by extrusion or by using hot melt drum unloaders); and then applying a release liner 15 to the adhesive layer that is applied to the first major surface of the roofing membrane.

### ASPECTS OF THE INVENTION

1. A roofing underlayment capable of adhering to a roof deck, said underlayment comprising:
(a) a roofing membrane having a first major surface and a second major surface;
(b) a pressure-sensitive adhesive disposed on the first major surface of the roofing membrane and comprising: (i) at least one of butyl rubber or polyisobutylene; (ii) a first liquid plasticizer; and (iii) a tackifier,
wherein the Tg of the adhesive is at most about 10° C.

2. A method of making a roofing underlayment comprising the steps of:
applying a pressure-sensitive adhesive to a first major surface of a roofing membrane, wherein the adhesive comprises: (i) at least one of butyl rubber or polyisobutylene; (ii) a first liquid plasticizer; and
applying a release liner over the adhesive layer that is applied to the first major surface of the roofing membrane,
wherein the Tg of the adhesive is at most about 10° C. The roofing underlayment of claim 1, wherein the first liquid plasticizer is a polybutene plasticizer.

3. A method of applying to a roof deck an underlayment comprising (a) a roofing membrane having a first major surface and a second major surface; (b) a pressure-sensitive adhesive layer disposed on the first major surface of the roofing membrane; and (c) a release liner applied over the pressure-sensitive adhesive, wherein the method comprises the steps of:
(a) removing the release liner from the roofing underlayment to expose the adhesive layer and
(b) adhering the underlayment to the roof deck by contacting the first major surface of the roofing membrane to the roof deck, wherein the adhesive comprises: (i) at least one of butyl rubber or polyisobutylene; (ii) a first liquid plasticizer; and (iii) a tackifier, wherein the Tg of the adhesive is at most about 10° C.

4. The roofing underlayment of Aspect 1 or the methods of Aspects 2 or 3, wherein the Tg of the adhesive is at most about 5° C., preferably at most about 0° C., more preferably at most about −5° C., and most preferably at most about −15° C.

5. The roofing underlayment or methods of any of Aspects 1-4, wherein the Tx of the adhesive is at least about 90° C., preferably between at least about 100° C., more preferably at least about 110° C., still more preferably at least about 130° C., and most preferably at least about 150° C.

6. The roofing underlayment or methods of any of Aspects 1-5, wherein the difference between the Tx of the adhesive and Tg of the adhesive is at least about 100° C., preferably between at least about 110° C., more preferably at least about 130° C., still more preferably at least about 150° C., and most preferably at least about 170° C.

7. The roofing underlayment or methods of any of Aspects 1-6, wherein the adhesive comprises:
(i) about 5 wt % to about 35 wt %, preferably about 10 wt % to about 30 wt %, more preferably about 12.5 wt % to about 25 wt % of the at least one of butyl rubber or polybutylene;
(ii) about 10 wt % to about 50 wt %, preferably about 15 wt % to about 45 wt %, more preferably about 17.5 wt % to about 40 wt % of the first liquid plasticizer; and
(iii) about 2.5 wt % to about 40 wt %, preferably about 4 wt % to about 35 wt %, more preferably about 5 wt % to about 30 wt % of the tackifier.

8. The roofing underlayment or methods of any of Aspects, 1-7 wherein the adhesive further comprises a styrene block copolymer.

9. The roofing underlayment or methods of Aspect 8, wherein the adhesive comprises about 2.5 wt % to about 25 wt %, preferably about 5 wt % to about 20 wt %, more preferably about 7.5 wt % to about 15 wt % of the styrene block copolymer.

10. The roofing underlayment or methods of Aspects 8, wherein the styrene block copolymer comprises a hydrogenated styrene block copolymer, preferably styrene-ethylene-butene-styrene (SEBS) block copolymer.

11. The roofing underlayment or methods of any of Aspects 1-10, wherein the adhesive further comprises a second plasticizer.

12. The roofing underlayment or methods of Aspect 11, wherein the adhesive comprises about 1 wt % to about 30 wt %, preferably about 2.5 wt % to about 20 wt %, more preferably about 5 wt % to about 10 wt % of the second plasticizer.

13. The roofing underlayment or methods of Aspect 11, wherein the combined weight percentage of the first liquid plasticizer and the second plasticizer is between about 15 wt % to about 50 wt %, preferably about 17.5 wt % to about 45 wt %, more preferably about 22.5 wt % to about 42.5 wt %

14. The roofing underlayment or methods of any of Aspects 1-13, wherein the adhesive further comprises a filler.

15. The roofing underlayment or methods of Aspect 14, wherein the adhesive comprises about 20 wt % to about 65 wt %, preferably about 30 wt % to about 60 wt %, more preferably about 40 wt % to about 55 wt % of the filler.

16. The roofing underlayment or methods of Aspect 14, wherein the filler is selected from the group consisting of silica and calcium carbonate.

17. The roofing underlayment or methods of any of Aspects 1-16, wherein the adhesive has a complex viscosity is about 5,000 to about 1,000,000 poise, preferably about 7,500 to about 750,000 poise, most preferably about 8,000 to about 600,000 poise.

18. The roofing underlayment or methods of any of Aspects 1-17, wherein the roofing membrane is made of a material selected from the group consisting of polyvinyl chloride (PVC), thermoplastic olefin (TPO), polyethylene and polypropylene, chlorinated polyethylene (CPE), chloro-sulphinated polyethylene (CSPE) and polyisobutylene (PIB).

19. The roofing underlayment or methods of any of Aspects 1-17, wherein the roofing membrane is made of a material selected from the group consisting of EPDM, butyl rubber, and neoprene.

20. The roofing underlayment or methods of any of Aspects 1-17, wherein the roofing membrane comprises woven polypropylene or polyethylene fabric, optionally having an ant-slip coating at the second major surface of the roofing membrane.

21. The roofing underlayment or methods of any of Aspects 1-20, wherein the roofing membrane is a single ply membrane.

22. The roofing underlayment or methods of any of Aspects 1-20, wherein the roofing membrane is a multi-layered structure.

23. The roofing underlayment or methods of any of Aspects 1-22, wherein the thickness of the roofing membrane is from about 5 miles to about 90 mils thick, preferably 10-45 mils, more preferably between about 10-35 mils and most preferably between about 10-25 or 10-20 mils.

24. The roofing underlayment or methods of any of Aspects 1-23, wherein the adhesive has a thickness between about 4 mils and about 50 mils, preferably between about 6 mils and about 30 mils, more preferably between about 8 mils and about 25 mils, and most preferably between about 10 mils and about 20 mils.

25. The roofing underlayment or methods of any of Aspects 1-23, wherein the adhesive has a thickness of at least about 16 mils, preferably at least about 18 mils, more preferably at least about 20 mils, and most preferably at least about 22 mils.

26. The roofing underlayment or methods of any of Aspects 1-25, total thickness of membrane and adhesive is greater than 40 mils

27. The roofing underlayment or methods of any of Aspects 1-26 further comprising a release liner adhered to the pressure sensitive adhesive.

28. The roofing underlayment or methods of any of Aspects 1-27, wherein the underlayment passes ASTM D1970-18, Section 7.5, for 14 days at 121° C. (250° F.).

29. The roofing underlayment or methods of any of Aspects 1-28, wherein the first liquid plasticizer is a polybutene plasticizer.

### EXAMPLES

The invention is further illustrated by way of the examples which are set forth below.

Samples of a synthetic roofing membrane, namely FT Synthetics Platinum, were coated with 16 mils of two butyl rubber based adhesives Formulations 1 and 2.

Formulation 1 contains:
22.1 wt % butyl rubber sold by as ExxonMobil as Butyl 268 having a Mooney viscosity (ML 1+8, 125° C.);
38.8 wt % polybutene plasticizer sold as Indopol H-300 by Ineos Corp. and having a molecular weight (Mn) of 1300 g/mol;
27.8% tackifying resin sold as Escorez 5600 by ExxonMobil Chemical which is an aromatic modified cycloaliphatic hydrocarbon resin having a softening point 102° C.;
11.1% block copolymer sold as Kraton G1657 by Kraton Polymers and having 13% styrene and 30% diblock and which is a styrene-ethylene/butylene-styrene block copolymer; and
0.2 of Irganox 1010%, an antioxidant.

Formulation 2 is a commercially available product from assignee sold as H9580K and contains: (1) 15 wt % of a butyl rubber; (2) 20 wt % of a polybutene plasticizer; (3) 8 wt % of a tackifier; (4) 6% of a second plasticizer; and (5) the remainder a significant amount of calcium carbonate and silica as a filler. The adhesives were coated on a silicone coated release paper and then covered with a silicone coated release film. The adhesives were then transferred to one side of the synthetic roofing underlayment.

The two samples as described above along with several samples of commercially available roofing underlayment products (such comparative examples labeled as CE-1 through CE-8) were tested according the ASTM D1970-18 as described in Section 7.5 “Thermal Stability”, but with the temperature increased to 250° F. (121° C.) instead of 70° C. (158° F.) as specified as in the test as written. The comments section in Table 1 below provides the general type of adhesive.

Four by four inch pieces of the laminates were adhered to a sheet of ⅜ inch plywood using the procedure specified under ASTM D1970-18, section 7.4.2.2. The plywood sheet was affixed to a test stand that held the plywood at a 45 degree angle to the floor of the oven. The panel was then exposed to a temperature of 250° F. (121° C.) for various periods of time. The results of these tests are given in Table 1, thus showing elevated temperature testing at 250° F. (121° C.).

TABLE 1

| | 24 hrs. | 1 week | 2 weeks | |
|---|---|---|---|---|
| Sample | at 250° F. | at 250° F. | at 250° F. | Comments |
| CE-1 | Pass | Pass | Fail | Butyl based mastic |
| CE-2 | Pass | Fail | Fail | SBC Asphalt |
| CE-3 | Fail | Fail | Fail | SBC Asphalt |
| CE-4 | Fail | Fail | Fail | SBC Asphalt |
| CE-5 | Pass | Fail | Fail | SBC Asphalt |
| CE-6 | Fail | Fail | Fail | SBC Asphalt |
| CE-7 | Fail | Fail | Fail | SBC Asphalt |
| CE-8 | Fail | Fail | Fail | Butyl Hybrid HM |
| Formulation 2 | Pass | Pass | Pass | Butyl Hybrid HM |
| Formulation 1 | Pass | Pass | Pass | Butyl based mastic |

The above tests reported in Table 1 show that adhesives of the present invention performed very well at high temperatures, especially compared to the eight commercially available formulations that were also tested. Indeed, the two formulations of the present invention were the only two adhesives to provide a roofing underlayment which passed this test at all three conditions, including for two weeks at 250° F.

One other aspect to consider is the environmental and oxidative stability of the pressure sensitive adhesive. For the roofing underlayment to remain permanently bonding to the roof, it must retain its pressure sensitivity for the life of the roof structure, which may be for many years. Many of asphaltic based adhesives and many of the butyl based adhesives will lose their tack after prolonged periods of time. The reason is that those adhesives contain raw materials that are not saturated, but instead contain asphalt, tackifying resins, or styrenic block copolymers that contain substantial amounts of unsaturated chemical bonds. For example, butyl rubber typically has between 1 and 3 percent unsaturation due to the isoprene which is added to the isobutylene to allow the butyl rubber to be cross-linked. This is a very small amount compared to styrenic block copolymers such as SIS or SBS based polymers which has about 50 times more unsaturation in the rubbery midblock section of the polymer. For this reason, the use of fully saturated block copolymers is needed so that the finished adhesive be as stable as possible to insure the bond to the roof remains intact for the life of the roof structure.

This can be tested by a number of different methods including environmental tests or oxidative testing such as differential scanning calorimetry.

Certain data about the adhesives tested was determined in accordance with ASTM D 4440-01 as described above. Temperature scans were run on the RDA-3 rheometer from 170 to −40° C. at 10 rad/sec on 25 mm parallel plates. Table 2 shows this data for Formulations 1 and 2 and CE-1 through CE-8.

TABLE 2

| | | | | Complex |
|---|---|---|---|---|
| | Tg | Tx | G′ @ 25° C. | Viscosity |
| Sample | (° C.) | (° C.) | (dyne/cm²) | at 121° C. |
| CE-1 | 17.4 | >170 | 3.4 × 10⁶ | 106,800 P |
| CE-2 | 41.2 | 102.4 | 1.2 × 10⁶ | 686 P |
| CE-3 | 15.5 | 109.4 | 6.3 × 10⁵ | 679 P |
| CE-4 | 36.9 | 92.7 | 2.8 × 10⁶ | 721 P |
| CE-5 | 16.2 | >58 | 5.7 × 10⁵ | 783 P |
| CE-6 | 57.8 | 110.6 | 4.7 × 10⁵ | 423 P |
| CE-7 | 34.9 | 83.0 | 1.6 × 10⁶ | 378 P |
| CE-8 | −1.3 | 72.5 | 9.3 × 10⁵ | 2362 P |
| Formulation 1 | −6.8 | 111.8 | 7.3 × 10⁵ | 9045 P |
| Formulation 2 | −21.2 | >170 | 2.6 × 10⁶ | 523,000 P |

Next, low temperature peel testing was conducted of roofing underlayments using Formulations 1 and 2, CE-1 through CE-7, and another commercially available roofing underlayment, CE-9, with a synthetic roofing membrane as used above. This study assessed the cold temperature adhesion to plywood per Section 7.4 of ASTM D1970. The specification calls out adhesion testing at 73° F. and 40° F. (4 +/−2° C.), and testing was also done at 25° F. to determine the behavior in even colder conditions.

The test method used was in accordance with ASTM D1970, Section 7.4—Adhesion to Plywood, as follows:
Condition the materials to be tested (underlayment, plywood, and roller) at the test temperature for at least four hours prior to assembly.
Cut underlayment sheet to 3″×8″ and bond a 3″×5″ area on a 3″×6″ plywood piece that is at least ¼″ thick and of APA Grade, Exposure 1. Make the bonds in a chamber set at the test temperature.
Roll three times back and forth with a roller that is 5″ in diameter, 5″ wide, and has a weight of 26 lbs.
Condition the bonded test specimens for at least one hour at the test temperature. Test five bonds for each underlayment at each temperature.
Perform the test on a constant rate of extension type tester at a crosshead speed of 2″/minute.
Separate the free end of the underlayment sheet from the plywood for a distance of about 2″, leaving about 3″ of bonded length. Clamp the free end of the plywood in one grip, turning back the free end of the underlayment and clamping it in the other grip. Peel at least three quarters of the bonded area.
Determine the peel strength as the average load over the course of the peel and report the average, and the standard deviation of the test values in kg/30.5 cm (lbs/ft width).

Per ASTM D1970, the minimum peel @ 40° F. is 2 lbs/ft width. Underlayments that failed at 40° F. were not tested at 25° F. Table 3 shows the results of the peel adhesion to plywood of the underlayments according to this test.

TABLE 3

| | Average Peel @ | | Average Peel @ | |
|---|---|---|---|---|
| | 40° F. (lbs/ft | Pass/ | 25° F. (lbs/ft | Pass/ |
| Underlayment | width) {Std | Fail @ | width) {Std | Fail @ |
| ID | Dev} | 40° F. | Dev} | 25° F. |
| CE-5 | 5.33 {1.32} | Pass | 0 {0} | Fail |
| CE-9 | 1.39 {0.31} | Fail | Not tested | |
| CE-7 | 0.41 {0.10} | Fail | Not tested | |
| CE-1 | 3.63 {0.56} | Pass | 5.65 | Pass |
| CE-4 | 0.58 {0.12} | Fail | Not tested | |
| CE-2 | 0.61 {0.04} | Fail | Not tested | |
| CE-3 | 4.30 {1.51} | Pass | 2.76 | Pass |
| CE-6 | 2.43 {1.23} | Pass | 0 {0} | Fail |
| Formulation 2 | 26.72 {13.12} | Pass | 44.40 | Pass |
| Formulation 1 | 54.58 {12.60} | Pass | 79.20 | Pass |

Both Formulations 1 and 2 far exceed the minimum adhesion to plywood requirement at temperatures as low as 25° F., with Formulation 1 providing the best peel strengths. CE-1 is the only competitive product known to have a butyl adhesive which it passed the minimum requirement at temperatures as low as 25° F.

Where a range of values is provided or where upper limits and lower limits are separately provided, it is understood that each intervening value, and any combination or sub-combination of intervening values, between the upper and lower limit of that range and any other stated or intervening value in that stated range, is encompassed within the range of values recited. In addition, the invention includes a range of a constituent which is the lower limit of a first range and an upper limit of a second range of that constituent. Where upper limits and lower limits are separately provided, any range from any of the lower limits to any of the upper limits is contemplated as part of the invention herein.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue or prior invention.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. A roofing underlayment capable of adhering to a roof deck, said underlayment comprising:
(a) a roofing membrane having a first major surface and a second major surface;
(b) a pressure-sensitive adhesive disposed on the first major surface of the roofing membrane and comprising: (i) at least one of butyl rubber or polyisobutylene; (ii) a first liquid plasticizer; and (iii) a tackifier,
wherein the Tg of the adhesive is at most about 10° C.

2. The roofing underlayment of claim 1, wherein the first liquid plasticizer is a polybutene plasticizer.

3. The roofing underlayment of claim 1, wherein the Tg of the adhesive is at most about 5° C.

4. The roofing underlayment of claim 1, wherein the Tx of the adhesive is at least about 90° C.

5. The roofing underlayment of claim 1, wherein the difference between the Tx of the adhesive and Tg of the adhesive is at least about 100° C.

6. The roofing underlayment of claim 1, wherein the adhesive comprises:
(i) about 5 wt % to about 35 wt % of the at least one of butyl rubber or polybutylene;
(ii) about 10 wt % to about 50 wt % of the first liquid plasticizer; and
(iii) about 2.5 wt % to about 40 wt % of the tackifier.

7. The roofing underlayment of claim 1, wherein the adhesive further comprises a styrene block copolymer.

8. The roofing underlayment of claim 7, wherein the adhesive comprises about 2.5 wt % to about 25 wt % of the styrene block copolymer.

9. The roofing underlayment of claim 7, wherein the styrene block copolymer comprises a hydrogenated styrene block copolymer.

10. The roofing underlayment of claim 1, wherein the adhesive further comprises a second plasticizer.

11. The roofing underlayment of claim 10, wherein the adhesive comprises about 1 wt % to about 30 wt % of the second plasticizer.

12. The roofing underlayment of claim 10, wherein the combined weight percentage of the first liquid plasticizer and the second plasticizer is between about 15 wt % to about 50 wt %.

13. The roofing underlayment of claim 1, wherein the adhesive further comprises a filler.

14. The roofing underlayment of claim 13, wherein the adhesive comprises about 20 wt % to about 65 wt % of the filler.

15. The roofing underlayment of claim 13, wherein the filler is selected from the group consisting of silica and calcium carbonate.

16. The roofing underlayment of claim 1, wherein the adhesive has a complex viscosity is about 5,000 to about 1,000,000 poise.

17. The roofing underlayment of claim 1, wherein the roofing membrane is made of a material selected from the group consisting of polyvinyl chloride (PVC), thermoplastic olefin (TPO), polyethylene and polypropylene, chlorinated polyethylene (CPE), chloro-sulphinated polyethylene (CSPE) and polyisobutylene (PIB).

18. The roofing underlayment of claim 1, wherein the roofing membrane is made of a material selected from the group consisting of EPDM, butyl rubber, and neoprene.

19. The roofing underlayment of claim 1, wherein the roofing membrane comprises woven polypropylene or polyethylene fabric, optionally having an ant-slip coating at the second major surface of the roofing membrane.

20. (canceled)

21. (canceled)

22. The roofing underlayment of claim 1, wherein the thickness of the roofing membrane is from about 5 mils to about 90 mils thick.

23. The roofing underlayment of claim 1, wherein the adhesive has a thickness between about 4 mils and about 50 mils.

24. The roofing underlayment of claim 1, wherein the adhesive has a thickness of at least about 16 mils.

25. The roofing underlayment of claim 1, total thickness of membrane and adhesive is greater than 40 mils

26. The roofing underlayment of claim 1 further comprising a release liner adhered to the pressure sensitive adhesive.

27. The roofing underlayment of claim 1, wherein the underlayment passes ASTM D1970-18, Section 7.5, for 14 days at 121° C. (250° F.).

28. A method of making a roofing underlayment comprising the steps of:
applying a pressure-sensitive adhesive to a first major surface of a roofing membrane, wherein the adhesive comprises: (i) at least one of butyl rubber or polyisobutylene; (ii) a first liquid plasticizer; and
applying a release liner over the adhesive layer that is applied to the first major surface of the roofing membrane,
wherein the Tg of the adhesive is at most about 10° C.

29. A method of applying to a roof deck an underlayment comprising (a) a roofing membrane having a first major surface and a second major surface; (b) a pressure-sensitive adhesive layer disposed on the first major surface of the roofing membrane; and (c) a release liner applied over the pressure-sensitive adhesive, wherein the method comprises the steps of:
(a) removing the release liner from the roofing underlayment to expose the adhesive layer and
(b) adhering the underlayment to the roof deck by contacting the first major surface of the roofing membrane to the roof deck, wherein the adhesive comprises: (i) at least one of butyl rubber or polyisobutylene; (ii) a first liquid plasticizer; and (iii) a tackifier, wherein the Tg of the adhesive is at most about 10° C.
